(19) United States
(12) Patent Application Publication
(10) Pub. No.: US 2007/0095297 A1
(43) Pub. Date: May 3, 2007

(54) Proximity activated pet fountain

(75) Inventor: Randal D. Boyd, Knoxville, TN (US)

Correspondence Address: PITTS AND BRITTIAN P C, P O BOX 51295, KNOXVILLE, TN, 37950-1295, US

(73) Assignee: Radio Systems Corporation

(21) Appl. No.: 11/265,063

(22) Filed: Nov. 2, 2005

(51) Int. Cl. A01K 7/00

(52) U.S. Cl. 119/74

(57) ABSTRACT

A pet fountain wherein water or pet food stored in a reservoir is dispensed from the reservoir and delivered to a receptacle accessible to the pet only on demand initiated by the physical presence of the pet in the proximity of the fountain.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to devices for watering pets. More particularly, this invention pertains to systems of this type which require minimum attention.

2. Description of the Related Art

Pet water fountains which dispense water to the pet on an as used basis are in common usage. Certain pet fountains include electronically driven pumps which move water from a reservoir, through a filter, thence introduce the water to the pet as a stream overflowing from the upper end of a drinking spout. These devices suffer the deleterious characteristics of: (1) required continuous operation of the pump to ensure that flowing water is available at all times for the pet, (2) running dry of water with continued operation of the pump, hence likely damage to the pump of a magnitude which requires its replacement, noise in the form of gurgling or the like when the water in the reservoir runs low, with concomitant fear and/or confusion by the pet, and other undesirable factors.

Water level indicators positioned in the reservoir have been employed in an effort to shut off the pump when such water level is too low for the pump to function. This leads to confusion of the pet when it seeks a drink of water from the device, and causing the pet to seek other source(s) of water, possibly from undesirable sources.

### BRIEF SUMMARY OF THE INVENTION

According to one embodiment of the present invention, there is provided a pet fountain wherein water or pet food stored in a reservoir is dispensed from the reservoir and delivered to a receptacle accessible to the pet only on demand initiated by the physical presence of the pet in the proximity of the fountain.

the system is provided with at least one proximity sensor system associated with the fountain and which functions to activate flow of drinking water from a reservoir of water to a drinking spout or the like and to continue such flow for such time as the pet is within the effective range of the sensor or for some preselected limited period of time. Notably, the water pumping action is commenced and water flow begins before the pet arrives at the drinking spout, thereby providing a time period within which the system can commence operation and generate water flow from the drinking spout shortly before or substantially immediately upon the pet arriving in position to drink water from the drinking spout. As noted, in the present system, water flow is continued for the duration of the pet's visit to the system and is halted upon the pet exiting the proximity of the system or after a preselected time period.

Further, in accordance with one aspect of the present invention, the limitation of the operating time of the pump expands the life span of the pump, reduces the rate of buildup in the filter, reduces the time between cleanings of the device, and other benefits.

Another embodiment provides multiple motion sensors are provided at spaced apart locations about the perimeter of the device to provide for the desired early detection of the approach of a pet toward the device, irrespective of which direction the pet uses in its approach to the device.

In another embodiment, the present invention provides coding capable of distinguishing between pets (dog or cat, for example), thereby limiting the use of the fountain to a preselected one or a class of users.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a schematic representation of one embodiment of a pet fountain embodying various of the features of the present invention and adapted to dispense water from a reservoir to a drinking spout accessible to the pet;

FIG. 2 is a block diagram of one embodiment of an electrically powered dispensing unit for the present pet fountain wherein the fountain is activated and/or operationally controlled employing one or more motion or heat sensors.

FIG. 3 is a block diagram of an embodiment of an electrically powered dispensing unit for the present pet fountain wherein the fountain is activated and/or operationally controlled employing an identifier, such as a radio frequency identification (RFID) tag carried by a pet;

FIG. 4 is a block diagram of one embodiment of an active RFID tag for use with the pet fountain of FIG. 3.

### DETAILED DESCRIPTION OF THE INVENTION

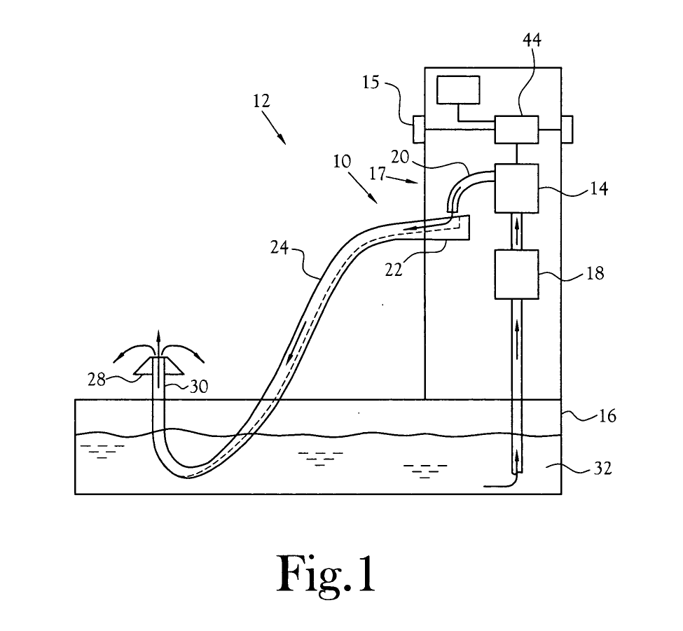

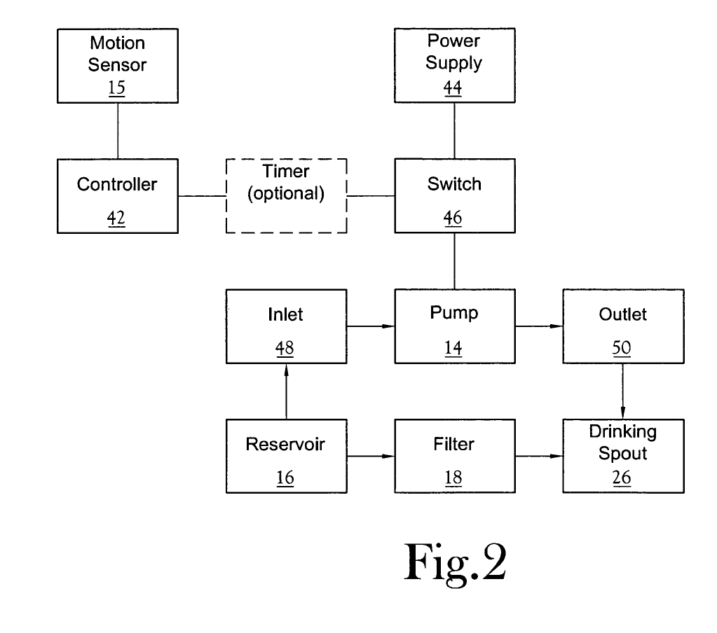

Referring to FIG. 1, there is depicted one embodiment of a circulation system 10 of a pet water fountain 12 which dispenses water to the pet on an as used basis in accordance with the present invention. The depicted fountain includes an electrically powered dispensing unit 17 including a pump 14 which is activated by one or more motion sensors 15 to move water from a reservoir 16, through a filter 18, thence an inlet 48 (see FIG. 2), to the pump 14, thence through an outlet 50 to deliver the filtered water into an open tray 22. The water flows from the tray down an open sluice 24, picking up oxygen from the ambient environment as the water flows down the sluice into and out of a drinking spout 26, thereby introducing the water to the pet as a stream 28 overflowing from the upper end 30 of the drinking spout.

FIG. 2 illustrates a block diagram of one embodiment of the pet fountain activated by motion. The pet fountain includes an electrically powered dispensing unit, including a motion sensor responsive to the presence of a moving object (i.e., a pet) within the sight of the motion sensor 40, a controller 42, and a power source 44, used in combination with a circulation system 10 such as depicted in FIG. 1.

In operation of the embodiment depicted in FIG. 2, when triggered, the motion sensor 15 generates an output signal that activates a switch 14. When activated, the switch connects the pump 14 to the power supply 44 to provide a stream 38 of fresh water flowing from the reservoir through the inlet 48 to the pump, thence through an outlet 50 from the pump to the drinking location (e.g. a drinking spout) for the pet to drink. The power source 44 of the pet fountain may be selected as a continuous or long-life power supply, such as a line voltage or long-life batteries. The power source is sized to power the circulation system and the detection system.

In the illustrated embodiment of FIG. 2, the electrically powered dispensing unit includes a controller 42 is connected between the motion sensor 15 and the switch 46. The output of the motion sensor is received at the controller. The controller has the responsibility for producing a second output that activates the switch. Typically, the controller provides a secondary function such as timing run of the pump for a selected time after the motion sensor is triggered. By maintaining a steady output to drive the switch for a selected time, the controller keeps fresh water flowing even if the motion sensor no longer detects the presence of the pet. One skilled in the art will appreciate the various devices that are suitable for use as the controller, including a standard timing circuit and any of the multitude of controllers and processors containing timing capabilities. A basic embodiment of the pet fountain omits the controller and directly connects the motion sensor to the switch. As long as the pet moves enough to trigger the motion sensor, the switch remains active and water continues to flow.

In the embodiment of FIG. 2, as the pet approaches the pet fountain, the motion sensor 15 responds to the radiation emitted from the animal (ie. passive infrared (PIR)) or to the changes in the signal emitted by the motion sensor (active sensing). If the presence of an animal is detected, the pet fountain activates the pump to circulate the water. Motion sensors, as the name implies, are generally triggered by motion from the radiation source. However, a pet that is drinking from the fountain is likely to be relatively motionless and, hence, invisible to the motion sensor. A timer or controller 42 linked to the detected motion event continues the water circulation for a specified time after the detected motion. If the sensitivity of the motion sensor is increased or the necessity of motion is removed, i.e., a heat sensor, an embodiment of the pet fountain is workable without the need for the timer.

Passive infrared (PIR) sensors are one common type of motion detector. A PIR sensor reacts to the infrared heat energy emitted by people and animals. Triggering occurs when the PIR sensor detects a change in infrared levels, such as when a warm object moves in or out of the sensor's field of view. PIR sensors are line-of-sight devices. They will not detect motion around corners and a person will not be detected if there is an obstruction, such as a partition, between the person and the detector.

A PIR sensor is a passive device that detects radiation but does not emit it. The PIR sensors used for the proximity-activated pet fountain are designed to be sensitive to objects emitting heat energy at a wavelength of around 10 microns, which is the peak wavelength of the heat energy emitted by warm-blooded animals. As a general rule, PIR sensors are not prone to false triggering.

PIR sensors are not very demanding of image quality. The objectives used to focus energy on the detector are typically unsophisticated reflective or refractive optics. Inexpensive sensors typically use refractive optics, such as a polyethylene Fresnel lens. Polyethylene is often used because it is one of the few inexpensive materials that transmit far infrared wavelengths. Unfortunately, polyethylene has a fairly high transmission loss. Using the Fresnel lens configuration allows a thinner lens that minimizes the loss. Other materials capable of transmitting far IR wavelengths include germanium, silicon, sapphire, and various exotic salts and minerals.

In addition to passive sensors, active sensors may be used to detect motion. Active sensors emit energy into the environment and measure changes in the reflected energy. Common types of active motion sensors emit light, sound, or microwave energy. By way of example, ultrasonic sensors (US) emit a high-frequency sound, above human and animal audibility, and listen for a change in frequency of the reflected sound. Active sensors are generally more sensitive that PIR sensors. In addition, active sensors are capable of monitoring larger areas than PIR sensors. The benefits of improved sensitivity and larger detection area, however, are somewhat offset by the disadvantage of increased false triggers. Because of the sensitivity, movement in the air due to opening or shutting a door or the cycling of an HVAC system can trigger an active sensor that is improperly placed or poorly adjusted. Hybrid sensors combine both active and passive sensors to obtain increased sensitivity but reduce the occurrence of false triggers.

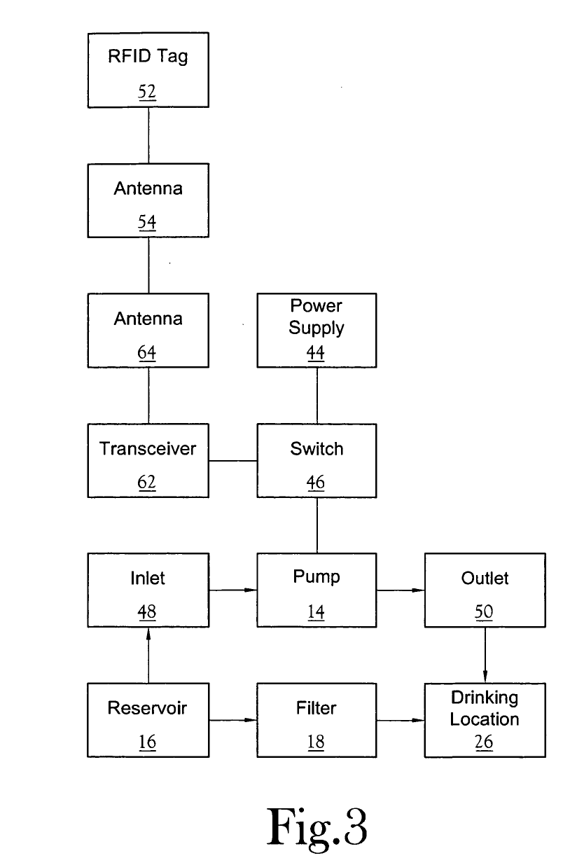

FIG. 3 illustrates a block diagram of another embodiment of the pet fountain including an electrically powered dispensing unit that is responsive to an identifier, such as a radio frequency identification (RFID) tag 52, carried by a pet.

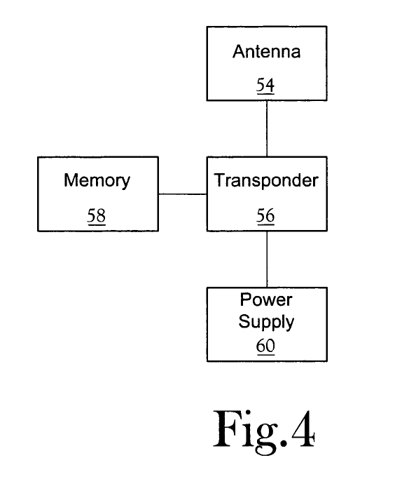

FIG. 4 illustrates a block diagram of an RFID tag for use with the pet fountain of FIG. 3. The RFID tag depicted in FIG. 4 comprises a transponder 56 which includes an antenna 54 a memory 58 and a power supply. 60 The use of an RFID tag allows the detection of a pet approaching the pet fountain from any angle and does not limit detection to the line-of-sight of a motion sensor. The embodiment of the pet fountain illustrated in FIG. 3 includes a transceiver 62, including an antenna 64, for transmitting a request and receiving a response from the RFID tag, and a power source 44. The transceiver is connected to the antenna designed to send and receive radio frequency signals of the desired wavelength. When a positive response is received from the RFID tag, the transceiver generates an output signal which activates a switch 46 that connects the pump 14 to the power supply. Powering the pump generates a flow of water for the hydration of the pet as described hereinabove. The power source of the pet fountain is often selected as a continuous or long-life power supply, such as a line voltage or long-life batteries. The power source preferably is sized to power the circulation system and the detection system.

Because pet fountains are commonly stationary, the type and weight of the power source can be of less than major significance. In one embodiment, the pet fountain is powered from line voltage. In another embodiment long-life batteries are used as weight is not a primary limiting factor. Because of the ready availability of power, the pet fountain is the active device in many embodiments. Generally, the pet fountain broadcasts a request-for-identification signal. As the pet approaches the pet fountain, the RFID tag carried by the pet receives the request-for-identification signal and broadcasts a response containing the identifier. Upon receipt of a proper response, the pet fountain activates the pump to circulate the water. Because the communication between the pet fountain and the RFID tag continues while the RFID tag remains in close proximity to the pet fountain and does not rely on movement of the pet, the activation of the pump need not be regulated with a controller, although a controller or timer can be used without departing from the scope and spirit of the present invention. The proper response depends upon the sophistication of the discernment between pets. The most basic embodiment uses a single code for all RFID tags, i.e., the RFID tag is linked to the brand or model of the pet fountain. All pets having the proper RFID tag will activate the pet fountain. In other embodiments, each RFID tag has a unique code and each pet fountain is programmed to accept only certain codes. This allows the pet fountains to have limited access. In other words, a dog wearing an RFID tag with one code can not activate the pet fountain linked to a differing code associated with the cat's RFID tag. The use of unique codes also allows separate profiles to be established for the pets. For example, the pet fountain is programmed to provide a thirty-second water flow when a first code is received and a forty-five second water flow in response to a second code.

Both active and passive RFID tags are suitable for use with the present invention. FIG. 4 illustrates an active RFID tag including a power supply, a transponder, a memory, and an antenna. Passive RFID tags do not include internal power supply. The radio frequency signal received at the antenna induces an electrical current to provide the necessary power for the RFID tag to transmit a response. The power generated is minimal and is typically sufficient for a brief transmission, such as an identifier that is stored in the memory. Without the need for a power supply, passive RFID tags are typically small and can be embedded under the skin or integrated into a collar worn by the pet. State-of-the-art RFID tags are as small as 0.4 mm×0.4 mm and readable from distances of approximately 10 mm to 6 meters.

Active RFID tags, such as that illustrated in FIG. 4, generally have a longer range than passive RFID tags, often up to tens of meters. Power consumption on active RFID tags is relatively low, which allows the battery in some active RFID tags to last up to 10 years. Active RFID tags are larger than their passive counterparts, with the majority of the increased size being the result of the inclusion of a battery, typically a coin cell. One skilled in the art will recognize other transponder devices and contactless chip cards that can be used to provide the desired identification function without departing from the scope and spirit of the present invention.

It will be further recognized by one skilled in the art that the fountain of the present invention may be employed for dispensing of pet foods in lieu of, or concomitantly with, the dispensing of water. More specifically, by substituting a source of food, for example particulate food, for the water discussed hereinabove, and substitution of a motorized feed screw, for example, for the pump and directing the output from the feed screw to a feed bowl or the like, one can readily dispense food to a pet. In this embodiment, the sensing and timing of the operation of the motorized feed screw may be controlled as by means of one or more of the systems depicted in the several Figures. Particularly useful for this purpose would be the RFID tag system depicted in FIG. 3. Other modifications to the proximity activated pet fountain of the present invention will be readily recognized by those skilled in the art. For example, the dispensing of the water and the food may be carried out simultaneously, each being offered to the pet in different receptacles from which the pet can gain access to the dispensed product.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A proximity pet fountain comprising:
a reservoir adapted to receive and contain a quantity of product selected from the group consisting of water and food for a pet,
a receptacle adapted to receive a dispensed product and present the same to the pet for consumption of the product,
an electrically powered dispensing unit interposed between said reservoir and said receptacle and, when activated, adapted to transfer said product from said reservoir to said receptacle,
at least one proximity sensor associated with said electrically powered dispensing unit and in a position to detect the proximity of a pet to said fountain and generating a signal suitable to activate said electrically powered dispensing unit and thereby commencing transfer for product from said reservoir to said receptacle, substantially concomitantly with the arrival of the pet at the fountain, and continuing transfer of said product for either a preselected time period or for that period of time when the pet remains within the field of said sensor.

2. The pet fountain of claim 1 wherein said proximity sensor is selected from the group comprising at least one of a motion sensor or a heat sensitive sensor or a RFID tag.

3. The pet fountain of claim 1 wherein said sensor is a motion sensor and multiple ones of said motion sensors are disposed about the fountain in position to detect the approach of a pet to the fountain from any one of multiple directions.

4. The pet fountain of claim 1 wherein said sensor is a heat activated sensor.

5. The pet fountain of claim 1 wherein said sensor comprises an RFID tag and said electrically powered dispensing unit includes a transceiver adapted to receive radio frequency signals from said RFID tag and generate an activation signal to said electronically activated dispensing unit.

6. The pet fountain of claim 1 wherein said product comprises water and said electrically powered dispensing unit comprises a pump and associated fluid communication means interposed between said reservoir and said receptacle.

7. The pet fountain of claim 1 wherein said product comprises pet food.

8. The pet fountain of claim 6 and including a filter interposed in said fluid communication means between said reservoir and said pump.

9. The pet fountain of claim 1 wherein said electrically powered dispensing unit includes a battery electrical power source.

10. A method for providing intermittent dispensing of a product from a reservoir of such product to a receptable accessible by a pet comprising the steps of
providing a reservoir of said product in a form which is dispensible therefrom by an electrically powered dispensing unit and a receptacle adapted to receive product dispensed from said reservoir,
providing an electrically powered dispensing unit between said reservoir and said receptacle,
detecting the proximity of a pet to said receptacle,
generating a first signal and communication thereof to said electrically powered dispensing system for activation of said electrically powered dispensing system and concomitant flow of product from said reservoir to said receptacle concomitant with the arrival of the pet at said fountain,
continuing said dispensing of product for either a preselected period of time or for the duration of the presence of the pet to the fountain, and cessation of dispensing of product upon the pet exiting the proximity of the fountain.

11. The method of claim 10 wherein said detection of the proximity of the pet to the fountain is effected by means of at least one sensor disposed in proximity to said fountain and selected form the group comprising a motion sensor, a heat sensor or an RFID tag.

12. The method of claim 10 wherein the product comprises water or pet food.
